(19) United States
(12) Patent Application Publication
(10) Pub. No.: US 2001/0031359 A1
(43) Pub. Date: Oct. 18, 2001

(54) Hollow microspheres

(76) Inventor: Christina Schmidt, Siegen (DE)

Correspondence Address: Stephan A. Pendorf, Pendorf & Cutliff, P.O. Box 20445, Tampa, FL, 33622-0445, US

(21) Appl. No.: 09/834,250

(22) Filed: Apr. 12, 2001

(30) Foreign Application Priority Data
Apr. 15, 2000 (DE) 100 18 824.9-43

(51) Int. Cl. B32B 5/16

(52) U.S. Cl. 428/402

(57) ABSTRACT

It is the task of the invention to provide a hollow microsphere for use in a surface coating, which is suitable for supporting an anticorrosion property of the coating, as well as a coating, in particular an anticorrosion layer with long lasting protective effect.

This task is inventively solved by selection of a hollow microsphere constituted such that it opens upon reaction with oxygen and/or water.

Thereby, on the one hand, oxygen and/or water are bound in the reaction products, and on the other hand, there are produced accesses into the hollow spaces, which can further receive substances. The thus bound oxygen and/or water, when using the inventive hollow microspheres in an anticorrosion layer, can no longer penetrate through the coating, and thus cannot damage the protected surface.

The invention concerns hollow microspheres for use in a surface coating according to the precharacterizing portion of Patent claim 1, the use thereof according to Patent claim 6 as well as an anti-corrosion layer according to Patent claim 7. Hollow microspheres of this general type are already generally known from DE 19730466 A1.

High demands are placed on the coatings for metallic surfaces, particularly with respect to the desired corrosion protection, and more particularly with respect to the durability of such protective effects in the face of strongly changing environmental influences, such as those to which vehicles of all types are frequently subjected.

It is known to zinc treat steel sheets. Zinced sheets can be further treated with organic coatings (for example chromate containing coatings) (DE-OS 19700319). It has however been shown, that in the operating conditions of vehicles, zinced steel sheets (or, as the case may be, organic coated zinced steel sheets) do not sufficiently offer a complete and durable corrosion protection.

Zinced sheets (or, as the case may be, organic pretreated zinced sheets) having a coating of zinc-dust paint, or a coating which contains rough milled zinc particles, does not provide a secure cathodic corrosion protection, since this type of zinc particle tends towards rapid oxidation and thereby becomes an electrical insulator. The electrical conductivity in the corrosion protection layer is thereby reduced so far that in particular in respect to the under-rusting important cathodic protective effects are lost.

The same applies for unzinced sheets in which filler materials comprised of electrically conductive metal particles, which exhibit a negative electrical potential relative to the potential of the sheets, have been incorporated into the organic coating materials for improvement of corrosion resistance. For steel sheets one could employ, for example, zinc, aluminum or magnesium. In this case also the metal particles oxidize, thereby reducing the cathodic protective effect.

The above described dissipation of the cathodic protection by the oxidation of the zinc material or the added metal particles in the organic protective layer leads thereto, that after prolonged exposure to air and humid atmosphere the initial corrosion protection drops relatively rapidly.

In DE 19730466 A1 an insulator coating or layer, in particular for off shore pipelines is described, which contains pressure resistant, temperature resistant, preferably inorangic hollow microspheres, which substantially increase the pressure resistance and temperature resistance of the coating. Any mention of the effect of the hollow microspheres on the anticorrosion properties of the coating is not to be found in DE 19730466 A1.

It is thus the task of the invention to provide hollow microspheres for use in a surface coating, which are capable of reinforcing the anticorrosion property of the layer, as well as the provision of a coating, in particular for an anticorrosion coating with long lasting protective effect.

The task is inventively solved by hollow microspheres which exhibit the characteristics of Patent claim 1. Further developments of the invention are set forth in the dependent claims.

With respect to the hollow microspheres to be employed in the surface coating layer, the task is inventively solved thereby, that the hollow microspheres are so designed, that they open upon reaction with oxygen and/or water.

Thereby, on the one hand, oxygen and/or water is bonded in the reaction products, and on the other hand, an increase in the number of accessible hollow spaces is produced, which can uptake further materials. The oxygen and/or water bound in this way, in the case of utilization of the inventive hollow microspheres in an anticorrosion coating, cannot penetrate to the substrate surface, and thus cannot damage it.

It is also advantageous to fill the hollow microspheres with inhibitors and/or antioxidants. Their release, upon opening of the hollow microspheres as a consequence of the reaction with oxygen and/or water, further increases the anticorrosion properties of the coating.

As suitable inhibitors one could select carbonic acids, amines, ketones, aldehydes and heterozyclic compounds. It is also possible to employ phosphates, benzoates, silicates, vanadates, tungstates, zirconates, borates or molybdates or similar substances.

Included among suitable antioxidants are vitamin C or the salts thereof or vitamin E or aromatic aldehyde compounds (for example 1,2- or 2,4-dihydroxybenzaldehyde, or phthal- or terephthaldialdehyde, or catechol) and similar substances such as for example amines, zirconates or benzotriazoles which develop their surface active effect after they have reacted with atmospheric oxygen.

It is also advantageous to construct the hollow microspheres of substances, of which the reaction products following reaction with oxygen and/or water act as inhibitors and/or antioxidants.

Suitable substances include for example polymerizates of inorganic salts, for example phosphate/phosphoric acid and/or silicate/silicic acid and/or borate/boric acids and/or tungstate/tungstic acid and/or molybdate/molybdic acid and/or organic compounds (for example ascorbinate/ascorbic acid; aromatic hydroxy- and/or aldehyde compounds; organic acids, for example sulfonic, phosphoric, carbonic acids) and their salts.

It is also advantageous to so construct the hollow microspheres, such that they assume the function of a dye or pigment.

This is possible for example by use of polymeric salts.

It is also advantageous when the diameter the hollow microsphere is selected to be smaller than approximately 50 μm. Hollow microspheres of this size are easily incorporated or compounded into anticorrosion layers without adversely effecting surface quality, in particular with respect to the roughness. Conventionally, as described for example in DE 19730466 A1, hollow microspheres with diameters of up to 200 μm are employed. This large size of spheres however results in undesirably rough surfaces.

The use of this type of hollow microspheres is advantageous for employment in any of the various layers, since they are constantly effective following long exposure to air and humidity. First the outer hollow microspheres react with oxygen and/or water and act in accordance with the invention. This effect is taken over by increasingly deeper layers after longer periods of time.

An anticorrosion layer which contains this type of hollow microsphere is particularly advantageous, since the anticorrosion characteristics thereof is constantly effective even after long exposures to air and humidity.

In the following a few selected embodiments of the inventive hollow microspheres will be described in greater detail.

Phosphoric acids (or phosphates) are polymerized and thereby form hollow microspheres. In the presence of oxygen and/or water the polymers cleave back to phosphoric acids (or phosphates).

Particularly useful herein is for example the employment of alkaline earth-, Al-, Zn-, Ti-, Mg- or Si-phosphates, since these dissolve into poorly soluble hydroxy compounds.

Also advantageous is the presence of ascorbic acids or ascorbinates, since in the reaction of phosphoric acids (or phosphates) with oxygen and/or water these form oxaluric acid or threonic acid, which act as corrosion inhibitors. Although advantageous is the presence of 2-keto-L-gluconic acid, the precursor of ascorbic acid.

In the following the production of a phosphoric ester with ascorbic acid is described by way of example, wherein respectively one mol (176 g) of ascorbic acid and 1 mol (141 g) phosphorpentoxide (P₂O₅) are heated at 165° C. in an autoclave at 100 bar for 60 minutes.

This reaction is a condensation reaction, wherein the P₂O₅ removes water from ascorbic acid, whereupon the acid polymerizes while eliminating water. At the same time the P₂O₅ reacts with the eliminated water to form phosphoric acid, which likewise takes part in the esterification of the ascorbic acid. In this manner there results a polymerizate of a phosphoric acid ester, and the formation of additional byproducts is substantially precluded. The ascorbic acid maintains its ability to reduce oxygen. When triggered by the environment, that is, upon contact with humidity or moisture, that is, upon reaction with water, there results ascorbic acid and phosphoric acid, both of which act as inhibitors.

The size of the hollow microspheres can be controlled by adjusting pressure and temperature, and is in the range of a few nanometers up to the size of zeolites. The example is based on buckey balls (named after Buckminster Fuller), for example C60-soccer balls. By the substantial exclusion of the production of by-products the purification of the end product is simplified.

Also conceivable is the polymerization of ascorbic acid and 2 keto-L-gluconic acid, with splitting off of water, into hollow microspheres. Such polymers react with oxygen to form oxalic acid and threonic acid, which act as corrosion inhibitors and antioxidants.

1. Hollow microspheres for employment in a surface coating, thereby characterized, that they are so constituted, that they open upon reaction with oxygen and/or water.

2. Hollow microspheres according to claim 1, thereby characterized, that they are filled with inhibitors and/or antioxidants.

3. Hollow microspheres according to one of the preceding claims, thereby characterized, that the reaction products produced by the reaction with oxygen and/or water act as inhibitors and/or antioxidants.

4. Hollow microspheres according to one of the preceding claims, thereby characterized, that they function as pigments or dyes or colorants.

5. Hollow microspheres according to one of the preceding claims, thereby characterized, that their diameter is less than approximately 50 μm.

6. Employment of hollow microspheres according to one of the preceding claims in a surface coating.

7. Anticorrosion layer, thereby characterized, that it contains hollow microspheres according to one of claims 1 through 5.
